(19) United States
(12) Patent Application Publication
(10) Pub. No.: US 2011/0010267 A1
(43) Pub. Date: Jan. 13, 2011

(54) REGULATION OF VALUE-BASED TRADE WEBSITE WITH A COMPUTER SYSTEM NETWORK

(76) Inventor: Derek Devries, San Francisco, CA (US)

Correspondence Address: RICHARD R. PETERS, 26512 AVENIDA VERONICA, MISSION VIEJO, CA, 92691, US

(21) Appl. No.: 12/627,074

(22) Filed: Nov. 30, 2009

Related U.S. Application Data
(63) Continuation-in-part of application No. 12/326,956, filed on Dec. 3, 2008.

(51) Int. Cl. G06Q 30/00

(52) U.S. Cl. 705/26.25

(57) ABSTRACT

Disclosed are a system, method and article of manufacture for are disclosed. A first relationship is created between a first node comprising a first commodity and a second node comprising a second commodity. The second commodity is of a greater or equal value to the first commodity. The first relationship comprises an obligation of the first node to provide the first commodity to the second node in the event of a trade. A second relationship is created between the second node and a third node comprising a third commodity. The third commodity is of a greater or equal value to the second commodity. The second relationship comprises an obligation of the first node to provide the first commodity to the second node in the event of the trade. The trade is initiated by creating a third relationship between the third node and the first node.

### CLAIM OF PRIORITY

This application is a Continuation-in-part of and claims priority to patent application Ser. No. 12/326,956 filed on Dec. 3, 2008. The Ser. No. 12/326,956 application is incorporated herein by reference.

### FIELD OF TECHNOLOGY

This disclosure relates generally to a communication system, and, more particularly, to a system, a method and an article of manufacture for regulation of a computerized value-based trading website with a computer system network.

### BACKGROUND

In an online trading system, a trader may desire a particular commodity of another trader. The trader may offer to trade the trader's commodity for the particular commodity of the other trader. The other trader may refuse. At the same time, the other trader may desire a third-party's commodity. The other trader may offer to trade with the third-party, however, the third party may refuse to trade. The third-party may desire the original trader's commodity. Thus, a situation may exist such that at least three different traders desire the commodities of each other in a circular pattern. A trading system that presents only a traditional one-to-one exchange method of effectuating trades may not be able to accommodate such a circular pattern.

### SUMMARY

A system, method, and article of manufacture for regulation of a value-based trade website with a computer-based network are disclosed. In one aspect, a computer-implemented method of regulating a value-based trade between a plurality of nodes of a computer system network is disclosed. The method includes creating a first relationship between a first node comprising a first commodity and a second node comprising a second commodity. The second commodity is of a greater or equal value to the first commodity. The first relationship comprises an obligation of the first node to provide the first commodity to the second node in the event of a trade.

In addition, the method further includes creating a second relationship between the second node and a third node comprising a third commodity. The third commodity is of a greater or equal value to the second commodity. The second relationship comprises an obligation of the first node to provide the first commodity to the second node in the event of the trade.

In addition, the method includes initiating the trade by creating a third relationship between the third node and the first node wherein the relationship comprises an obligation of the third node to provide the third commodity to the first node.

In addition, the commodity may comprise an article of trade or a service. The method may include generating a fourth relationship between the second node and a fourth node comprising a fourth commodity. The fourth commodity may be of a greater or equal value to the second commodity. The relationship may comprise an obligation of the second node to provide the second commodity to the fourth node in the event of the first node accept the fourth commodity.

In another aspect, a computerized apparatus for regulating a trade of a plurality of commodities with a computer network is disclosed. The computerized apparatus includes a server collecting a commodity relationship data. The commodity data comprises a first relationship between a first commodity and a second commodity. The commodity data further comprises a second relationship between the second commodity and a third commodity. The first relationship comprises an obligation to provide the first commodity to a holder of the second commodity if the third commodity is offered for the first commodity. The second relationship comprises an obligation to provide the second commodity to a holder of the third commodity if the third commodity is offered for the first commodity. The third commodity is of a greater or equal non-monetary value than the second commodity. The second commodity is of a greater or equal non-monetary value than the first commodity. In addition, a database is coupled to the server. The database stores the commodity data.

In addition, the first relationship may be formed by an offer to trade the first commodity with the second commodity. The offer may be declined and the holder of the first commodity may agree to be bound by an obligation to provide the first commodity to the holder of the second commodity if a holder of the third commodity offers the third commodity to the holder of the first commodity in exchange for the holder of the second commodity providing the second commodity to the holder of the third commodity. The non-monetary value may be assigned by a holder of the commodity. The server may support the operation of an online commodity-trading website. The server may support the operation of a commodity-trading website. The first relationship and the second relationship may be effectuated though the commodity-trading website.

In yet another aspect, an article of manufacture is disclosed. The article of manufacture comprises a computer readable medium having computer program logic recorded thereon for establishing a network configuration supporting a computerized value-based trading system in accordance with a plurality of protocols of a network architecture. The article of manufacture further comprises a first field comprising data representing a first commodity offered for trade on a website supported by the network configuration. In addition, a second field comprises data representing a second commodity offered for trade on the website supported by the network configuration. Furthermore, a third field comprises data representing a third commodity offered for trade on the website supported by the network configuration. The article of manufacture also comprises a fourth field comprising data representing a first relationship between the first commodity and the second commodity, wherein the first relationship comprises an obligation of a holder of the first commodity to provide the first commodity to a holder of the second commodity in the event of the holder of the first commodity accepting the third commodity. In addition, the article of manufacture comprises a fifth field comprising data representing a second relationship between the first commodity and the second commodity, wherein the second relationship comprises an obligation of the holder of the second commodity to provide the second commodity to a holder of the third commodity in the event of the holder of the first commodity accepting the third commodity. In addition, the network configuration may comprise a server, a computer network and a database.

The system, method and article of manufacture disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 illustrates the general architecture of a computerized value-based trading system that operates according to one embodiment.

FIG. 2 shows a schematic visualization illustrating the organization of an example triangle trade effectuated by a computerized value-based trading system, according to one embodiment.

FIG. 3A shows another schematic visualization illustrating the organization of an example triangle trade effectuated by a computerized value-based trading system, according to one embodiment.

FIG. 3B shows yet another schematic visualization illustrating a cluster node, according to one embodiment.

FIG. 3C shows yet another schematic visualization illustrating the organization of an example triangle trade effectuated by the computerized value-based trading system, according to one embodiment.

FIG. 4A is a flow chart illustrating the effectuation of an example triangle trade with the computerized value-based trading system website, according to one embodiment.

FIG. 4B is a continuation of the flow chart of FIG. 4A, according one embodiment.

Other features of the present embodiments will be apparent from the accompanying drawings and from the detailed description that follows.

### DETAILED DESCRIPTION

Disclosed are a system, method, and article of manufacture for regulation of a computerized value-based trading website with a computer system network. Although the present embodiments have been described with reference to specific example embodiments, it will be evident that various modifications and changes may be made to these embodiments without departing from the broader spirit and scope of the various claims.

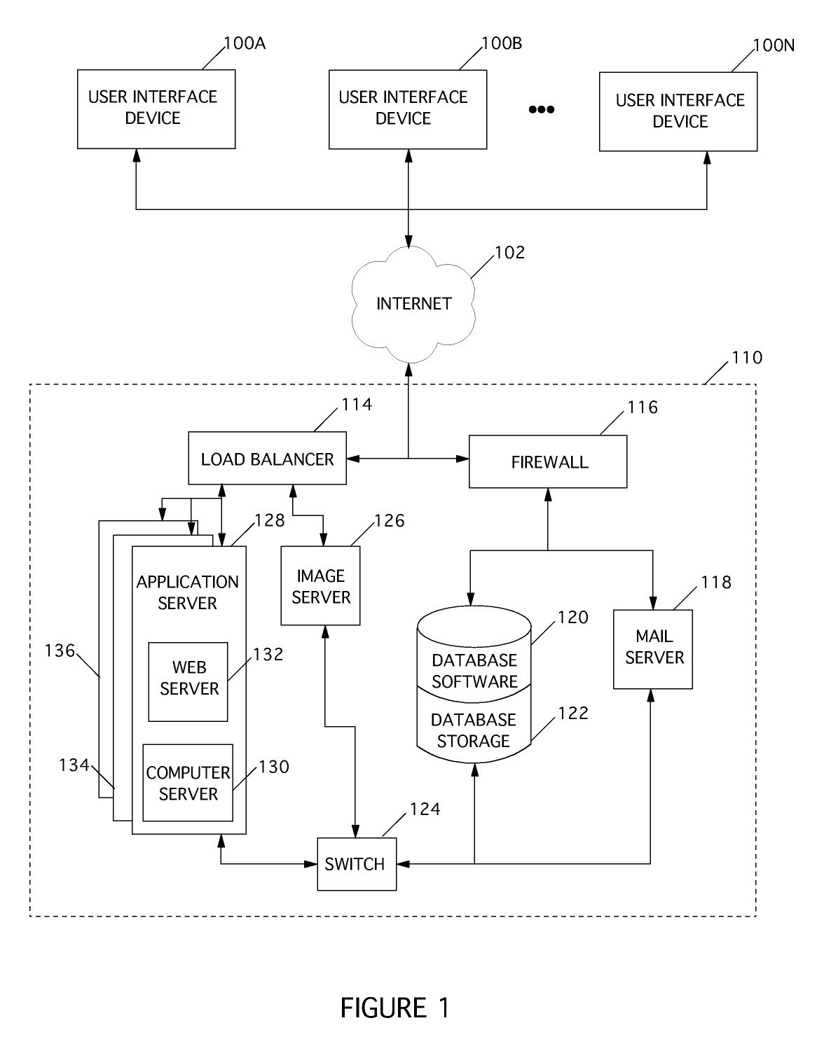

FIG. 1 illustrates the general architecture of a computerized value-based trading system that operates according to one embodiment. A plurality of user interface devices 100 A-N are communicatively coupled with a computerized apparatus 110 for regulating the trading of a plurality of commodities via the Internet 102. In other embodiments, any computer network (a wide area network, a local area network) may be utilized to communicatively couple the user interface devices 100 A-N to the computerized apparatus 110. The user interface devices 100 A-N may be any device capable of presenting data, including, but not limited to, cellular telephones, television sets, personal computers or portable media players. As used herein, the term “Internet” 102 generally refers to any collection of distinct computer networks working together to appear as a single network to a user. The computer networks may use the standardized Internet Protocol Suite (TCP/IP) and/or other similar protocols to communicate with one another. The Internet 102 provides file transfer, remote log in, electronic mail, news and other services. As described herein, the exemplary network of FIG. 1 is for descriptive purposes only. Although the description may refer to terms commonly used in describing particular networks such as the Internet 102, the description and concepts equally apply to other public and private computer networks, including systems having architectures dissimilar to that shown in FIG. 1. For example and without limitation thereto, the system of FIG. 1 can locate application in public as well as private networks, such as a closed university social system, or the private network of a company.

In one embodiment, the load balancer 114 balances the traffic load across multiple mirrored servers 128, 134 and 136 and a firewall 116 provides protection from unauthorized access to the computerized apparatus 110. The components of the computerized apparatus 110 may be connected via a computer network (e.g. a local area network or a wide area network).

In one embodiment, the computerized apparatus 110 includes a plurality of application servers 128, 134 and 136. This configuration may increase the scalability of the computerized apparatus 110. The application server 128 comprises a web application server 132 and a computer server 130 that serves as the application layer of the computerized apparatus 110. The web application server 132 may be a system that sends out web pages in response to Hypertext Transfer Protocol (HTTP) requests from remote browsers (i.e. user interface devices 100 A-N). The web server 132 may provide a graphical user interface to the user interface devices 100 A-N in the form of web pages.

The image server 126 stores and provides digital images to the other components of the computerized apparatus 110 and to the user interface devices 100 A-N. The image server 126 manages digital photographs and other human viewable images. The image server 126 may be configured separately from the web server 132. This configuration may increase the scalability of the computerized apparatus 110. In other example embodiments, the web server 132 and the image server 126 may be configured together. Examples of image formats that can be managed by the image server 126 include, but are not limited to, Graphical Interchange Format (“GIF”), Joint Photographics Experts Group (“JPEG”), or Portable Network Graphics (“PNG”), or Tagged Image File (“TIF”).

The mail server 118 sends and receives electronic messages to and from user interface devices 100 A-N. The mail server 118 is a repository for e-mail messages received from the Internet 102. The mail server 118 also manages the transmission of electronic messages (e.g. e-mail). The mail server 118 includes a storage area, a set of user definable rules, a list of users and a series of communication modules.

The database software 120 and database storage 122 are also included. The switch 124 may allow the components of the computerized apparatus 110 to be communicatively coupled via a local area network (LAN) or a wide area network (WAN). The firewall 116 blocks unauthorized access to the components of the computerized apparatus 110 while permitting authorized communications. The firewall 116 may be a device or set of devices configured to permit, deny, encrypt, decrypt, or proxy all (in and out) computer traffic between different security domains based upon a set of rules and other criteria.

The computer server 130 may include a central processing unit (CPU), a random access memory (RAM) for temporary storage of information, and a read only memory (ROM) for permanent storage of information. The computer server 130 may be generally controlled and coordinated by an operating system. The operating system may control allocation of system resources and performs tasks such as, inter alia, processing, scheduling, memory management, networking, and I/O services. Thus, the operating system is resident in a system memory and executed by CPU and coordinates the operation of the other elements of the computerized apparatus 110.

The computerized value-based trading system is accessible to users via a website supported by the web server 132. A particular commodity for trade may be represented on one or more pages of the website. Information about a particular user, commodity and activity (e.g. trade, commodity value, triangle trade obligation, etc.) may be stored as data in the database storage 122.

A webpage accessible to a second user may include virtual buttons and other virtual input devices displayed on a computer screen that allow a user to offer a second commodity for trade in exchange for a first commodity available on the website. A set of rules may govern the behavior of users when trading commodities. For example, in an example embodiment, the set of trading rules described in U.S. patent application Ser. No. 12/326,956 may govern (in whole or in part depending on the particular embodiment) user behavior and commodity trades within the computerized value-based trading system. Another webpage accessible to the first user may include virtual buttons and other virtual input devices displayed on a computer screen used to view the second commodity offered for trade as well as information about the second commodity. The other webpage may also include virtual buttons other virtual input devices displayed on the computer screen to allow the first user to accept, reject or offer a triangle trade obligation for the second commodity of the second user in response to the offer to trade from the second user.

A triangle trade obligation describes a relationship that allows the first user to reject an offer for trade while maintaining an obligation to provide the first user's commodity to the second user if the second user can locate a third commodity from a third user that is acceptable to the first user. The third party then provides the third commodity to the first user, the first user provides the first commodity to the second user and the second user provides the second commodity to the third user. The triangle trade obligations may grow to n-number of users and commodities.

An inter-process communications protocol (IPCP) (i.e. a set of rules for marshalling and un-marshalling parameters and results) may be utilized by the computerized apparatus 110. The IPCP may occur at the point where the control path in the calling and called process enters or leaves the IPCP domain. The IPCP may include a set of rules for encoding and decoding information transmitted between multiple processes. In other example embodiments, the computerized apparatus 110 may provision of dynamically scalable and virtualised resources as a service over the Internet 102 on a utility basis (e.g. with a cloud computing infrastructure).

The holder of a commodity may be a person or a commercial entity (e.g. a corporation) that utilizes the online commodity-trading website provided and supported by the web server 132 and the other components of the computerized apparatus 110. The holder may utilize the computerized apparatus 110 to offer a particular commodity for trade. Other holders of other commodities may then utilize the computerized apparatus 110 to accept offers from the holder and/or create offers themselves. The holders may utilize the user interface devices 100 A-N to transmit and receive data with the components of the computerized apparatus 110.

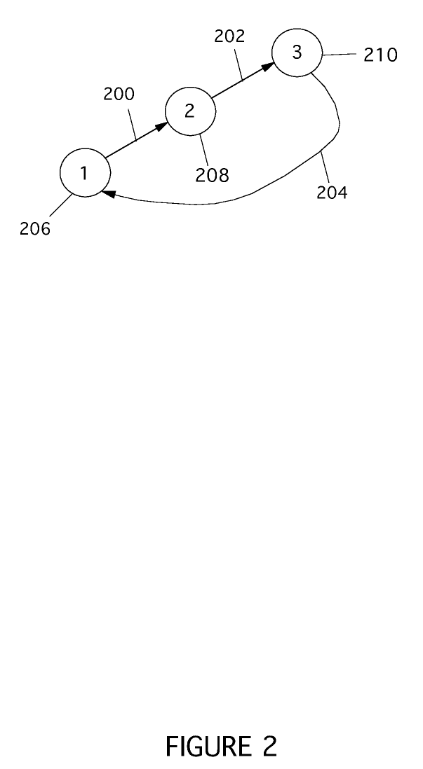

FIG. 2 shows a schematic visualization illustrating the organization of an example triangle trade effectuated by a computerized value-based trading system, according to one embodiment. The circles in the graph represent nodes. A node represents a particular commodity offered for trade by a particular user within the value-based commodity trading system supported by the computer apparatus 110. The value of the commodity appears within the node. An arrow represents an obligation to provide the commodity to a node pointed to by the arrow in the event of an effectuated triangle trade.

More particularly, in FIG. 2, each user-commodity combination is represented by a node. The value of the commodity of the first node 206 is one (1). The second node 208 offers to trade a commodity of a value of two (2) with the first node 206. The first node 206 may reject the offer to trade and instead offer to create a triangle trade obligation 200. The second node 208 accepts and the triangle trade obligation 200 is created. The third node 210 offers to trade a commodity of value three (3) with the second node 208. The second node 208 may reject the offer to trade and instead offer to create a triangle trade obligation 202. The third node 210 may accept the offer to create triangle trade obligation 202. The third node 210 may then offer commodity of value three (3) to the first node 206 in order to initiate the triangle trade. If the first node 206 accepts the offer from the third node 210, a triangle trade occurs. The first node provides the commodity of the first node 206 to the second node 208 according to the triangle trade obligation 200. The second node provides the commodity of the second node 208 to the third node 210 according to the triangle trade obligation 202. The third node provides the commodity of the third node to the first node 206 in operation 204.

Information regarding the triangle trade obligations 200-202 may be stored in the database storage 122. The web server 132 may update the various web pages of the computerized value-based trading system website to indicate the created relationships and associated commodities. Users represented by nodes 206-210 may access the website in order to, inter alia, establish the relationship, review the status of offered trades, search other commodities listed on the website and create triangle trade obligations.

It should be noted that is some example embodiments, the users represented by the nodes 206-210 may have some flexibility to arrange the time and place of provision of the article of trade or service represented by the commodity. Accordingly, a strict chronological sequence of the provision of commodities may not be required to effectuate the triangle trade.

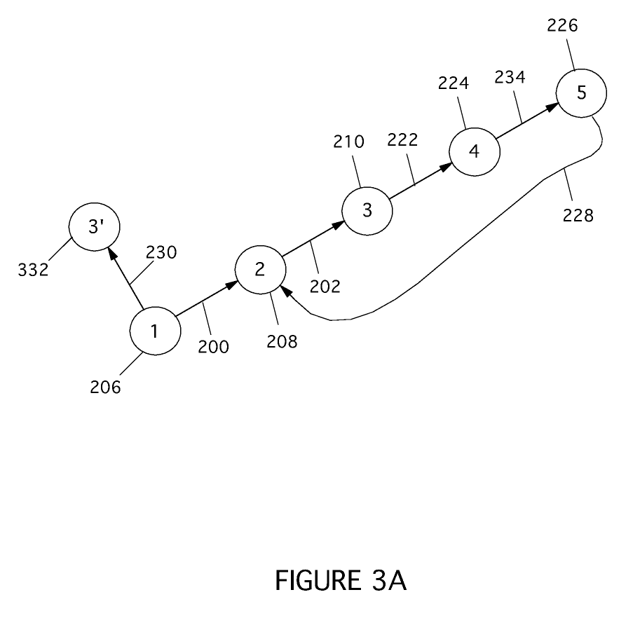

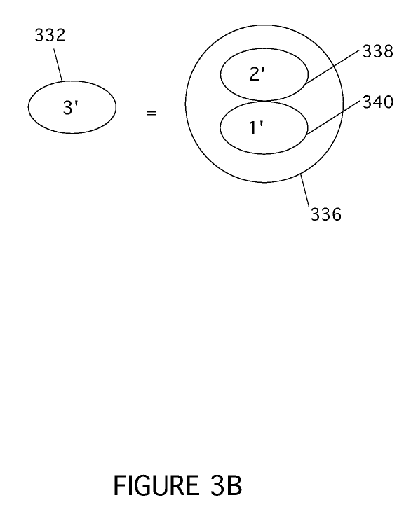

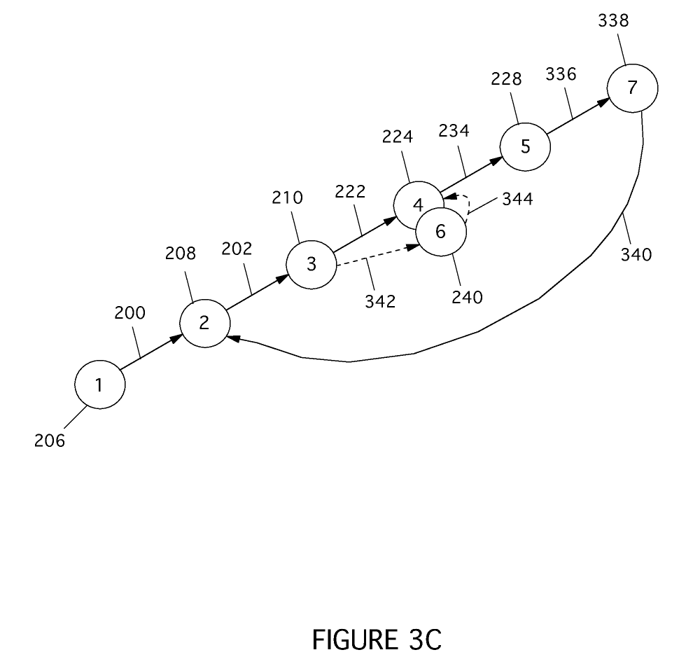

In other example embodiments, each node may serve as a basis for a new branch of triangle trade obligations (see FIGS. 3A-B infra). Thus, a particular node may have n-number of arrows pointing away from it to n-number of nodes. In one example embodiment, only a single arrow of a single direction may be extant between any given pair of nodes. Also, a node in a branch may provide notice on the website of what types of commodities the node would be willing to accept. This mechanism may be used to decrease the period of time a branch exists before a triangle trade is effectuated.

FIG. 3A shows another schematic visualization illustrating the organization of an example triangle trade effectuated by the computerized value-based trading system, according to one embodiment. The value of the commodity of the first node 206 is one (1). The second node 208 may offer to trade a commodity of a value of two (2) with the first node 206. The first node 206 may reject the offer to trade and instead offer to create a triangle trade obligation 200. The second node 208 accepts and the triangle trade obligation 200 is created. The third node 210 may offer to trade a commodity of value three (3) with the second node 208. The second node 208 may reject the offer to trade and instead offer to create a triangle trade obligation 202. The third node 210 may accept the offer to create triangle trade obligation 202. The fourth node 224 may offer to trade a commodity of value four (4) with the third node 210. The third node 210 may reject the offer to trade and instead offer to create a triangle trade obligation 222. The fourth node 224 may accept the offer to create triangle trade obligation 222. The fifth node 226 may offer to trade a commodity of value of five (5) with the fourth node 224. The fourth node 224 may reject the offer to trade and instead offer to create a triangle trade obligation 234. The fifth node 226 may accept the offer to create triangle trade obligation 234.

The fifth node 226 may offer to provide the commodity of the value of five with any node below it on the branch. If the lower node accepts the offer, a triangle trade is then effectuated for all nodes above the lower node. For example, if the fifth node 226 offers the commodity of the value of five to the second node 208, the triangle trade is effectuated where the second node 208 fulfills obligation 202, the third node 210 fulfills obligation 222 and the fourth node 224 fulfills obligation 234. In addition to the fifth node 226 provides the commodity of the value of five to the second node 208 in operation 228. Information regarding the triangle trade obligations 200-222 may be stored in the database storage 122. The web server 132 may update the various web pages of the computerized value-based trading system website to indicate the created relationships and associated commodities. Users represented by nodes 206-226 may access the website to, inter alia, establish the relationship, review offered trades, search other commodities listed on the website and create triangle trade obligations.

In addition, FIG. 3A illustrates the property of a single node with multiple triangle trade obligations. The first node 206 has a triangle trade obligation 200 with the second node 208 and a triangle trade obligation 230 with the third prime node 332. According to one example embodiment, if either triangle trade obligation is effectuated the other triangle trade obligation is immediately nullified. All subsequent triangle trade obligations above the particular nullified triangle trade obligation are also nullified.

FIG. 3B shows a schematic visualization illustrating a cluster node, according to one embodiment. For example, the third prime node 332 may represent a cluster 336 of other commodities with a sum value equal to three. For example, the cluster 336 may include a second prime node 338 and a first prime node 340. In the event of a triangle trade, the commodities represented by these nodes will be provided to the first node 206. The cluster 336 may be created according to several methods. For example, in one embodiment, the two prime node 338 may offer to create the cluster 336 with the one prime node 340. The two nodes may be motivated by a desire to collectively increase their trading potential in the computerized value-based trading system. If the one prime node 340 accepts the offer, the cluster 336 is then created. Certain rules may be introduced into the computerized value-based trading system that govern the creation and behavior of cluster nodes. For example, the computerized value-based trading system may require that all member nodes consent to an offer for a triangle trade. In other example embodiments, a single user may coalesce several items together to create a cluster node.

FIG. 3C shows yet another schematic visualization illustrating the organization of an example triangle trade effectuated by the computerized value-based trading system, according to one embodiment. The value of the commodity of the first node 206 is one (1). The second node 208 may offer to trade a commodity of a value of two (2) with the first node 206. The first node 206 may reject the offer to trade and instead offer to create a triangle trade obligation 200. The second node 208 accepts and the triangle trade obligation 200 is created. The third node 210 may offer to trade a commodity of value three (3) with the second node 208. The second node 208 may reject the offer to trade and instead offer to create a triangle trade obligation 202. The third node 210 may accept the offer to create triangle trade obligation 202. The fourth node 224 may offer to trade a commodity of value four (4) with the third node 210. The third node 210 may reject the offer to trade and instead offer to create a triangle trade obligation 222. The fourth node 224 may accept the offer to create triangle trade obligation 222. The fifth node 226 may offer to trade a commodity of value of five (5) with the fourth node 224. The fourth node 224 may reject the offer to trade and instead offer to create a triangle trade obligation 234. The fifth node 226 may accept the offer to create triangle trade obligation 234. The seventh node 338 may offer to trade a commodity of value of seven (7) with the fifth node 228. The fifth node 228 may reject the offer to trade and instead offer to create a triangle trade obligation 336. The seventh node 338 may accept the offer to create triangle trade obligation 336.

A sixth node 240 may comprise a sixth user and sixth commodity outside of the branch. The sixth node may want the commodity of the third node 210. However, the commodity of the third node 210 is already under an obligation 234 to be provided to the fourth node 224 in the event. In a particular example embodiment, the sixth node 240 may offer the fourth node 224 the opportunity to create an obligation 344 and obligation 342. The obligation 344 and obligation 342 replace the triangle trade obligation 222. Obligation 344 comprises an obligation on the part of the sixth node 240 to provide the commodity associated with the sixth node to the fourth node 224 in the event of a triangle trade. Obligation 342 comprises an obligation on the part of the third node 210 to provide the commodity of the third node to the sixth node 240 in the event of a triangle trade. The triangle trade may be effectuated when the seventh node 338 offers the commodity associated with the seventh node to the second node 208 in operation 340.

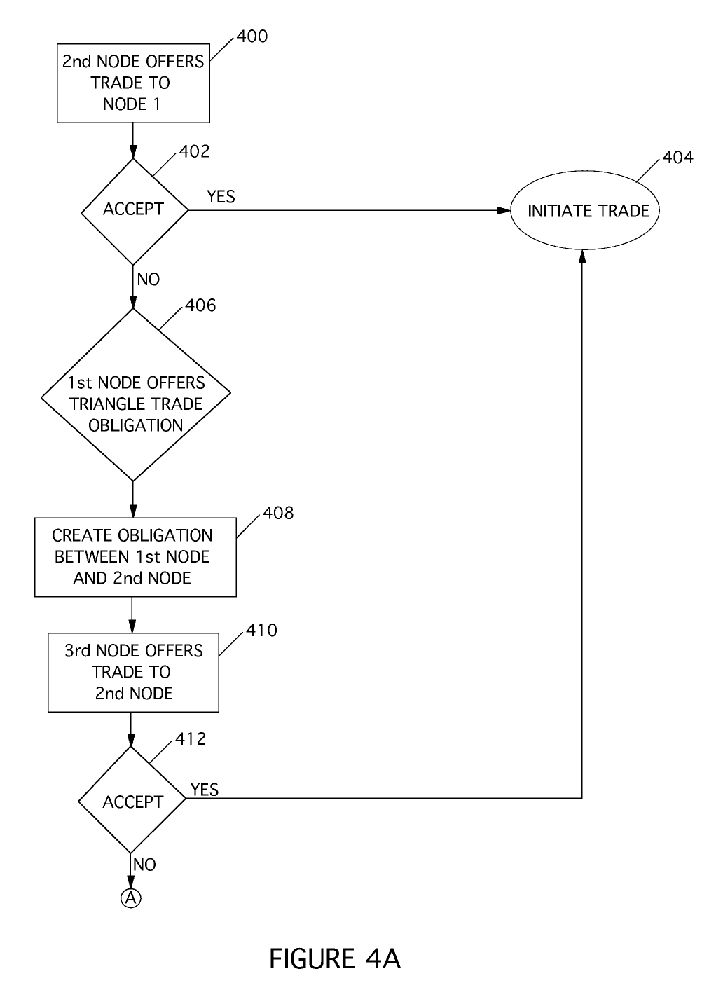

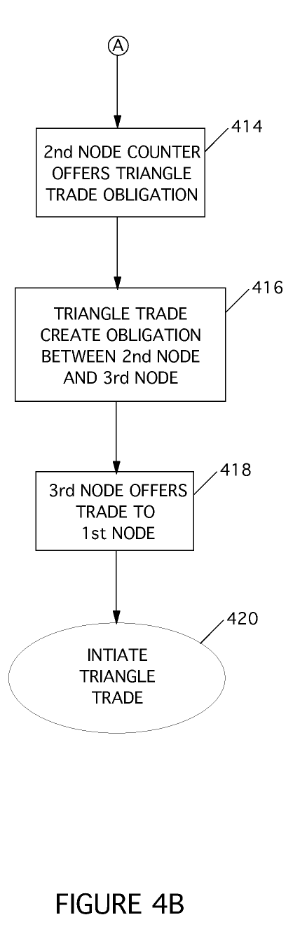

FIG. 4A is a flow chart illustrating the effectuation of the example triangle trade of FIG. 2 with the computerized value-based trading system website, according to one embodiment. Each node represents a user of the computerized value-based trading system website and at least one commodity. In operation 400, the second node 208 offers to trade a commodity of a value of two (2) with the first node 206. For example, the user associated with the second node 208 may access a web page displaying information about the commodity associated with the first node 206. The web page may include a virtual button that allows the second user 208 to offer a trade with the user of the first node 206. The web pages may be provided by the web server 132. In operation 402, the first node 206 may accept or reject the offer. The user associated with the first node may have a private home page provided by the web server 132. The web page may provide a virtual button for rejecting the offer and making a counter offer to create a triangle trade obligation. The application server 128 may include a module for managing trading and relationships between the various users of the computerized value-based trading system website. If the first node 206 accepts the offer a trade operation is initiated in operation 404. The homepage of the user associated with the first node may include a virtual button to accept the trade offer. The application server 128 may manage the trade. For example, the application server 128 may cause the mail server 118 to transmit an email message to the users of both nodes informing them that the trade has occurred and information as to the terms of the trade. In operation 406, the first node 206 may reject the offer to trade and instead offer to create a triangle trade obligation 200. In operation 408, the triangle trade obligation 200 is created if the second node 208 accepts. The web server may provide a home page to the user associated with the second node 208. The home pages of various users may provide information as to the extant triangle trades attached to the commodities of the user being presented for trade. The web server 132 and the application server 128 may coordinate with the image server 126 to present images of the various commodities on the various homepages of the system. For example, the image server 126 may present the commodity of the first node on the home page of the second node indicating the extant triangle trade obligation with the first node in text. In operation 410, the third node 210 offers to trade a commodity of value three (3) with the second node 208. In operation 412, the second node 208 may accept or reject the offer. If the second node 208 accepts the offer a trade operation is initiated 404.

FIG. 4B is a continuation of the flow chart of FIG. 4A, according one embodiment. In operation 414, the second node 208 counter offers to create a triangle trade obligation with the third node 210. The second node 208 may reject the offer to trade and instead offer to create a triangle trade obligation 202. In operation 416, the third node 210 may accept the offer to create triangle trade obligation 202. In operation 418, the third node 210 may then offer commodity of value three (3) to the first node 206 in order to initiate the triangle trade. If the first node 206 accepts the offer from the third node 210, a triangle trade occurs in operation 420. In operation 420, the first node provides the commodity of the first node 206 to the second node 208 according to the triangle trade obligation 200. In operation 420, the second node provides the commodity of the second node 208 to the third node 210 according to the triangle trade obligation 202. In operation 420, the third node provides the commodity of the third node to the first node 206 in operation 204. The database storage 122 may store information regarding the triangle trade. Users may utilize the user interface devices 100 A-N to access, via the Internet 102, the websites provided and managed by the web server 132.

Although the present embodiments have been described with reference to specific example embodiments, various modifications and changes may be made to these embodiments without departing from the broader spirit and scope of the various embodiments. For example, the various devices, modules, etc. described herein may be enabled and operated using hardware circuitry (e.g., CMOS based logic circuitry), firmware, software or any combination of hardware, firmware, and software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

1. A computer-implemented method of regulating a value-based trade between a plurality of nodes of a computer system network comprising:
creating a first relationship between a first node comprising a first commodity and a second node comprising a second commodity, wherein the second commodity is of a greater or equal value to the first commodity, and wherein the first relationship comprises an obligation of the first node to provide the first commodity to the second node in the event of a trade;
creating a second relationship between the second node and a third node comprising a third commodity, wherein the third commodity is of a greater or equal value to the second commodity, and wherein the second relationship comprises an obligation of the first node to provide the first commodity to the second node in the event of the trade; and
initiating the trade by creating a third relationship between the third node and the first node wherein the relationship comprises an obligation of the third node to provide the third commodity to the first node.

2. The computer-implemented method of claim 1, wherein the commodity comprises at least one of an article of trade and a service.

3. The computer-implemented method of claim 2, wherein the first relationship is created once the first node accepts the obligation to provide the first commodity to the second node in the event of a trade.

4. The computer-implemented method of claim 3, wherein the second relationship is created once the second node accepts the obligation to provide the second commodity to the third node in the event of a trade.

5. The computer-implemented method of claim 4, wherein the third relationship is created once the third node offers the third commodity for trade to the first node.

6. The computer-implemented method of claim 5 further comprising:
generating a fourth relationship between the second node and a fourth node comprising a fourth commodity, wherein the fourth commodity is of a greater or equal value to the second commodity, and wherein the relationship comprises an obligation of the second node to provide the second commodity to the fourth node in the event of the first node accept the fourth commodity.

7. The computer-implemented method of claim 6, wherein the trade is conducted over a computer system network with at least one server.

8. The computer-implemented method of claim 7, wherein the fourth relationship is nullified if any trade occurs between at least one of the first node, the second node and the third node.

9. The computer-implemented method of claim 8, wherein a plurality of other nodes and other relationships are intermediary between the second node and the third node.

10. The computer-implemented method of claim 8, wherein a node comprises a commodity of a specified value offered for trade in a computerized-trading network.

11. The computer-implemented method of claim 8, wherein the first relationship, the second relationship and the third relationship are effectuated with a website supported by a server.

12. The computer-implemented method of claim 1, wherein a computer-readable medium comprising computer executable instructions is adapted to perform the method of claim 1.

13. An computerized apparatus for regulating a trade of a plurality of commodities with a computer network comprising:
a server collecting a commodity relationship data, said commodity relationship data comprising a first relationship between a first commodity and a second commodity, and a second relationship between the second commodity and a third commodity, wherein the first relationship comprises an obligation to provide the first commodity to a holder of the second commodity if the third commodity is offered for the first commodity, wherein the second relationship comprises an obligation to provide the second commodity to a holder of the third commodity if the third commodity is offered for the first commodity, wherein the third commodity is of a greater or equal non-monetary value than the second commodity, and wherein the second commodity is of a greater or equal non-monetary value than the first commodity; and
a database coupled to the server, said database storing the commodity relationship data.

14. The computerized apparatus of claim 13, wherein the first relationship is formed by an offer to trade the first commodity with the second commodity, and wherein the offer is declined and the holder of the first commodity agrees to be bound by an obligation to provide the first commodity to the holder of the second commodity if a holder of the third commodity offers the third commodity to the holder of the first commodity in exchange for the holder of the second commodity providing the second commodity to the holder of the third commodity.

15. The computerized apparatus of claim 14, wherein the commodity comprises at least one of an article of trade and a service.

16. The computerized apparatus of claim 15, wherein the non-monetary value is assigned by a holder of the commodity.

17. The computerized apparatus of claim 16, wherein the server supports the operation of a commodity-trading website.

18. The computerized apparatus of claim 17, wherein the first relationship and the second relationship are effectuated though the commodity-trading website.

19. An article of manufacture comprising:
a computer readable medium having computer program logic recorded thereon for establishing a network configuration supporting a computerized value-based trading system in accordance with a plurality of protocols of a network architecture;
a first field comprising data representing a first commodity offered for trade on a website supported by the network configuration;
a second field comprising data representing a second commodity offered for trade on the website supported by the network configuration;
a third field comprising data representing a third commodity offered for trade on the website supported by the network configuration;
a fourth field comprising data representing a first relationship between the first commodity and the second commodity, wherein the first relationship comprises an obligation of a holder of the first commodity to provide the first commodity to a holder of the second commodity in the event of the holder of the first commodity accepting the third commodity; and
a fifth field comprising data representing a second relationship between the first commodity and the second commodity, wherein the second relationship comprises an obligation of the holder of the second commodity to provide the second commodity to a holder of the third commodity in the event of the holder of the first commodity accepting the third commodity.

20. The article of manufacture of claim 19, wherein the network configuration comprises a server, a computer network and a database.
